(19) United States
(12) Patent Application Publication
(10) Pub. No.: US 2016/0290043 A1
(43) Pub. Date: Oct. 6, 2016

(54) WINDOW SHADE WITH SPRING ASSIST

(71) Applicant: DRAPER, INC., Spiceland, IN (US)

(72) Inventor: Jerry L. McPherson, Jr., Charlottesville, IN (US)

(21) Appl. No.: 15/035,435

(22) PCT Filed: Nov. 21, 2014
(86) PCT No.: PCT/US14/66914

§ 371 Date: May 9, 2016

Related U.S. Application Data
(60) Provisional application No. 61/907,338, filed on Nov. 21, 2013.

(51) Int. Cl. E06B 9/56; E06B 9/80; E06B 9/44; E06B 9/68; E06B 9/62; E06B 9/66; E06B 9/78

(52) U.S. Cl. CPC E06B 9/56; E06B 9/66; E06B 9/80; E06B 9/78; E06B 9/68; E06B 9/62; E06B 9/44; E06B 2009/785

(57) ABSTRACT

A window shade system includes a roller, fabric wrapped on the roller, a flexible line wrapped around a drum that supports the fabric, a clutch coupled to the drum, a constant torque spring applying torque to the fabric, and a variable torque spring that applies torque to clutch.

### RELATED APPLICATION

The present application claims priority to U.S. Provisional Patent Application Ser. No. 61/907,338, filed Nov. 21, 2013, titled “WINDOW SHADE SYSTEM WITH SPRING ASSIST,” to McPherson, the entire disclosure of which is expressly incorporated by reference herein.

### BACKGROUND AND SUMMARY OF THE INVENTION

This invention relates to window shades systems. More particularly, the present invention relates to window shades systems having torque generators, such as springs.

Additional features of the disclosure will become apparent to those skilled in the art upon consideration of the following detailed description when taken in conjunction with the accompanying drawings.

According to the present disclosure, a window shade system is provided including a roller, fabric coupled to the roller to wrap and unwrap from the roller, a roller adapter sized to be received within a window shade roller, a drum, a flexible line supporting the fabric and coupled to the drum to wrap and unwrap from the drum, a clutch coupled to the drum to control rotation of the drum, a first torque generator urging the fabric in a first direction, and a second torque generator urging the fabric in a second direction opposite the first direction.

According to another aspect of the present disclosure, a window shade system is provided including a roller, fabric coupled to the roller to wrap and unwrap from the roller, a roller adapter sized to be received within a window shade roller, a drum, a flexible line supporting the fabric and coupled to the drum to wrap and unwrap from the drum, and a clutch coupled to the drum to control rotation of the drum. The fabric is moveable between a first position and a second position. Torque applied to the clutch is positive when the fabric is in the first position and negative when the fabric is in the second position.

According to another aspect of the present disclosure, a window shade system is provided including a roller, fabric coupled to the roller to wrap and unwrap from the roller, a roller adapter sized to be received within a window shade roller, a drum, a flexible line supporting the fabric and coupled to the drum to wrap and unwrap from the drum, and a clutch coupled to the drum to control rotation of the drum. The fabric is moveable between a first position, a second position, and an intermediate position between the first and second positions. The absolute torque applied to the clutch decreases when the fabric moves between the first and intermediate positions and increases when the fabric moves between the intermediate and second positions.

According to another aspect of the present disclosure, a window shade system is provided including a roller, fabric coupled to the roller to wrap and unwrap from the roller, a roller adapter sized to be received within a window shade roller, and a clutch coupled to the drum to control rotation of the drum. The clutch includes a pull line operable to release the clutch and wrap or unwrap the fabric from the roller from first, second, and intermediate positions. A first required amount of force applied to the pull line during movement of the fabric between the first and intermediate positions is substantially constant. A second required amount of force is applied to the pull line during movement of the fabric between the intermediate and second positions. The second required amount of force increases from the first amount of required force during movement of the fabric from the intermediate position to the second position.

According to another aspect of the present disclosure, a window shade system is provided including a roller, fabric coupled to the roller to wrap and unwrap from the roller, a roller adapter sized to be received within a window shade roller, a drum, at least one flexible line supporting the fabric and coupled to the drum to wrap and unwrap from the drum, a clutch coupled to the drum to control rotation of the drum, the clutch having a maximum torque limit, and a torque generator coupled to the clutch. The at least one flexible line applying torque above the maximum torque limit.

According to another aspect of the present disclosure, a window shade system is provided including a roller, fabric coupled to the roller to wrap and unwrap from the roller, a roller adapter sized to be received within a window shade roller, a drum, at least one flexible line supporting the fabric and coupled to the drum to wrap and unwrap from the drum, and a torque generator coupled to at least one flexible line. The torque generator includes a plurality of spring modules applying substantially constant torque to the at least one flexible line during rotation of at least a portion of the torque generator.

### BRIEF DESCRIPTION OF THE DRAWINGS

A detailed description particularly refers to the accompanying figures in which:

The above-mentioned and other features of this disclosure, and the manner of attaining them, will become more apparent and the invention itself will be better understood by reference to the following description of an embodiment of the invention taken in conjunction with the accompanying drawings, wherein:

FIG. 1 is a diagrammatic view of a window opening at least partially covered by a window shade system;

FIG. 2 is a side elevation view of the window shade system of FIG. 1 showing the system including upper and lower rollers for raising and lowering window shade fabric;

FIG. 3 is a graph showing amounts of torque applied to a clutch of the window shade system of FIG. 1;

FIG. 4 is front view of a preferred embodiment window shade system;

FIG. 5 is a cross-sectional view of the window shade system of FIG. 4;

FIG. 6 is perspective view of a torque generator of the window shade system of FIG. 4;

FIG. 7 is a cross-sectional view of the torque generator of FIG. 6;

FIG. 8 is an exploded assembly view of the torque generator of FIG. 6;

FIG. 9 is a cross-section view of another torque generator of the window shade system of FIG. 4;

FIG. 10 is an exploded assembly view of the torque generator of FIG. 9;

FIG. 11 is a perspective view of the bracket assembly of the window shade system of FIG. 4;

FIG. 12 is an exploded assembly view of the bracket assembly of FIG. 11;

FIG. 13 is front view of another preferred embodiment window shade system; and

FIG. 14 is a cross-sectional view of the window shade system of FIG. 13.

### DETAILED DESCRIPTION OF THE DRAWINGS

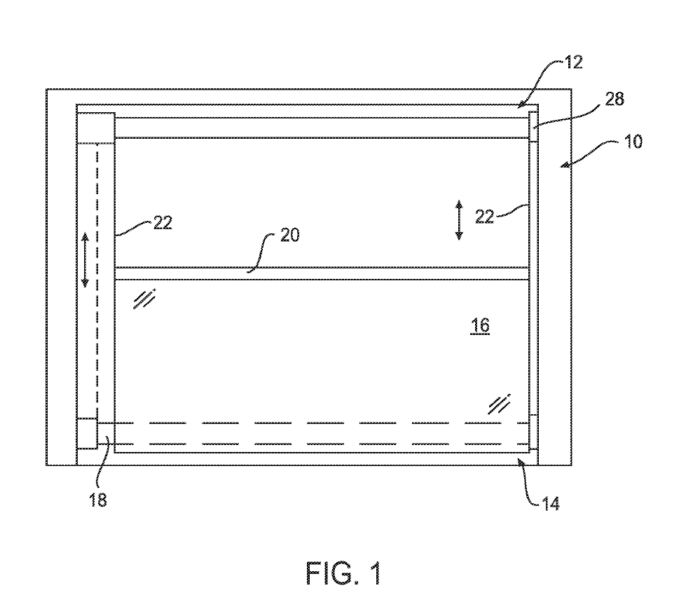

A window shade system 10 in accordance with the present disclosure is shown in FIG. 1. System 10 an upper roller assembly 12 and a lower roller assembly 14. Upper and lower roller assembles 12, 14 facilitate the raising and lowering of fabric 16 of system 10 that wraps and unwraps from lower roller 18 of lower roller assembly 14 as fabric 16 is raised and lowered. Although the terms upper and lower are used to describe roller assemblies 12, 14, these assemblies may be positioned in different relative arrangements. For example, roller assembly 12 may be positioned below or at the same level as roller assembly 14 in some embodiments.

System 10 includes a bar 20 that supports fabric 16 and a cable 22 that supports each end of bar 20. Upper roller assembly 12 includes an upper roller 24 upon which cable 22 winds and unwinds during raising and lowering of fabric 16. Cable 22 is one type of flexible line suitable for use with system 10. Other suitable flexible lines may include chain, rope, cord, string, twine, straps, etc.

To raise fabric 16 of shade system 10, upper roller 24 is rotated in direction 26 to wind up cable 22. Cable 22 pulls up on bar 20 to unwrap fabric 16 from lower roller 18. To lower fabric 16, upper roller 24 is rotated in a direction opposite of direction 26 to unwind cable 22. As cable 22 unwinds, lower roller 18 takes in fabric 16 so that fabric 16 wraps around lower roller 18. To hold fabric 16 in a desired position, upper roller assembly 12 includes a clutch 28, such as the XD clutch sold by Draper, Inc. of Spiceland, Indiana, and manual clutches described in U.S. Pat. No. 5,361,822 to Nijs, and PCT Patent Application Publication No. WO 2012/122108 to Seib, U.S. Pat. No. 4,372,432 to Waine et al., the disclosures of which are expressly incorporated herein, or a motor, such as the tubular electric motors described in U.S. Pat. Nos. 5,220,721 to Thierry and 6,668,982 to LaGarde, the disclosures of which are expressly incorporated by reference herein.

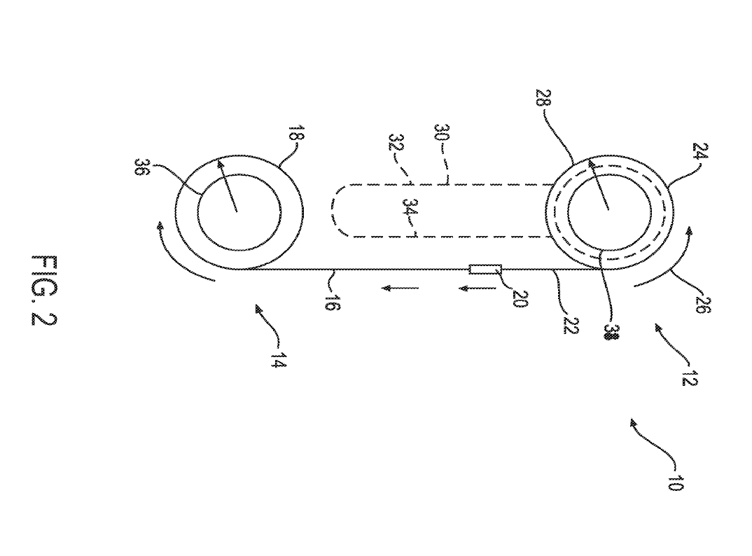

Clutch 28 brakes/holds upper roller 24 in place against torque/forces applied to upper roller 24 through cable 22 and other sources of torque/force. In FIG. 2, a manual clutch 28 is illustrated that includes a pull chain 30. To raise fabric 16, a user pulls on left side 32 of chain 30 supplying enough force/torque to overcome the static state of window shade system 10. To lower fabric 16, a user pulls on right side 34 of chain 30 supplying enough force/torque to overcome the static state of window shade system 10. Pull chain 30 is one type of pull line suitable for system 10. Other suitable flexible lines may include cable, rope, cord, string, twine, straps, etc.

In addition to its own weight, cable 22 bears the weight of bar 20 and fabric 16. As fabric 16 is raised, the amount of weight borne by cable 22 increases. As a result, the more fabric 16 is raised, then more force/torque fabric 16 applies to upper roller assembly 12 including clutch 28.

According to the preferred embodiment of the present disclosure, a lower torque generator 36 is provided to assist in wrapping fabric 16 around lower roller 18 when upper roller 24 is unwinding cable 22 and lowering fabric 16. Lower torque generator 36 creates additional downward force on cable 22 in addition to the weight of bar 20 and fabric 16 that must be supported by upper roller assembly 12 and torque that is countered by clutch 28. Thus, to assist in wrapping fabric 16 around lower roller 18, additional force is applied to cable 22 and additional torque is applied to upper roller assembly 12 because of the torque supplied by lower torque generator 36. This additional force requires that a user applies more force to left side 32 of chain to raise fabric 16. But, this additional force also assists in lowering fabric 16 by pulling on right side 34 of chain 30.

According to the preferred embodiment of the present disclosure, lower torque generator 36 is a substantially constant torque spring. As lower roller 18 releases or unwraps fabric 16, the amount of torque applied by torque generator 36 remains substantially constant, but may increase or decrease. Preferably, the amount of constant torque varies by less than about 50% from start to finish of wrapping and unwrapping fabric 16 from lower roller 18. According to other embodiments, the torque may vary be more or less than 50%, such as 5%, 10%, 20%, 30%, 40%, 60%, 80%, 100%, 200%, etc.

According to other embodiments, lower torque generator 36 may be an electric motor, a gear set, or any other device known to one of ordinary skill in the art that generates torque. These other embodiments may provide substantially constant torque, torque that consistently increases as lower roller 18 releases or unwraps fabric 16, or torque that consistently decreases as lower roller 18 releases or unwraps fabric 16.

According to the present disclosure, window shade system 10 is configured to offset or reduce the influence of the weight of bar 20 and fabric 16 on the raising and lowering of fabric 16 and the force resulting from lower torque generator 36. According to the present disclosure, upper roller assembly 12 includes an upper torque generator 38 to assist in winding cable 22 around upper roller 24 when lower roller 18 is unwrapping fabric 16 as it is raised. Depending on the rotational position of upper roller 24, upper torque generator 38 subtracts from or adds to the absolute amount of torque held by clutch 28. This subtraction and addition reduces the absolute amount of torque held by clutch 28 as discussed below. Additionally, this subtraction and addition reduces the top end force that must be applied to chain 30 by a user to raise and/or lower fabric 16.

According to the preferred embodiment of the present disclosure, upper torque generator 36 is a torsion spring that increases its torque output as it is turned. As upper roller 24 collects or winds cable 22, the absolute amount of torque applied by upper torque generator 38 decreases substantially proportionally to the number of revolutions. Preferably, the amount of torque output by upper torque generator 36 increases as the number of revolutions applied to it increase. According to the preferred installation of the present embodiment, upper torque generator 38 is pre-loaded to apply negative torque (i.e. counterclockwise torque in FIG. 2). As fabric 16 is raised, the absolute value of this negative torque decreases.

According to other embodiments, upper torque generator 38 may be an electric motor, a gear set, or any other device known to one of ordinary skill in the art that generates torque. These other embodiments may provide substantially constant torque, torque that consistently increases as upper roller 24 releases or unwinds cable 22, or torque that consistently decreases as upper roller 24 release or unwinds cable 22.

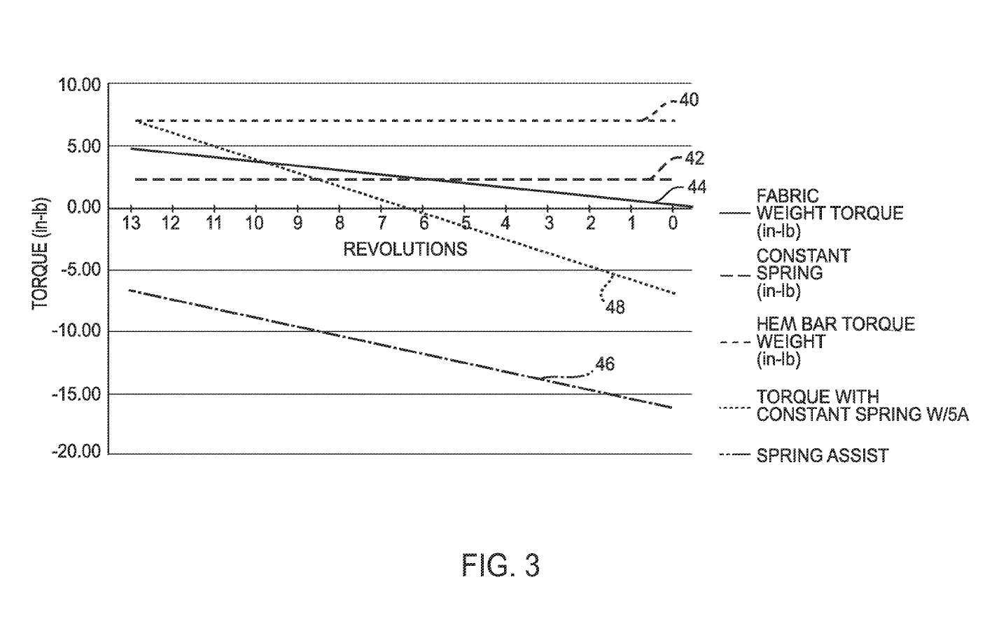

The amount of torque held by clutch 28 is a function of at least the weight of cable 22 unwound from upper roller 24, the weight of hem bar 20, the amount of fabric unwrapped from lower roller 18, the amount of torque applied to cable 22 by lower torque generator 36, and the amount of torque applied by upper torque generator 38. As shown in FIG. 3, the amount of torque applied by hem bar 20 is substantially constant as a function of the number of revolutions of lower and upper rollers 18, 24 as illustrated by linear curve 40. As discussed above, lower torque generator 36 has a substantially constant torque output as illustrated by linear curve 42. According to the present example, as fabric 16 unwraps from fully retracted at zero (0) revolutions to fully extended at 13 revolutions, the amount of torque attributable to fabric 16 increases as illustrated by linear curve 44. According to the present example, upper torque generator 38 has substantially linear torque output as a function of the number of revolutions of upper roller 24 as illustrated by linear curve 46. Because upper torque generator 38 is pre-loaded, it applies torque when fabric 16 is in the lowered position.

As shown in FIG. 3, hem bar 20 (linear curve 40), fabric 16 (linear curve 44), and lower torque generator 36 (linear curve 42) apply positive (i.e. in a clockwise direction as shown in FIG. 2) torque to clutch 28 which has a tendency to work against raising fabric 16 and works toward lowering fabric 16. Upper torque generator 38 applies negative torque (i.e. a counterclockwise direction as shown in FIG. 2) to clutch 28 which has a tendency to work toward raising fabric 16 and works against lowering fabric 16. Thus, upper torque generator 38 counters the torque applied to clutch 28 that is attributable to hem bar 20, fabric 16, and lower torque generator 36.

As shown in FIG. 3, substantially linear curve 48 is the summation of the torque applied by hem bar 20, fabric 16, lower torque generator 36, and upper torque generator 38. The total torque applied to clutch 28 varies as lower and upper rollers 18, 24 rotate. At zero (0) revolutions, the torque applied to clutch 28 is negative (i.e. counterclockwise in FIG. 2). As lower and upper rollers 18, 24 rotate, the amount of torque applied to clutch 28 decreases to zero (0), becomes positive (i.e. clockwise in FIG. 2), and continues increasing until 13 revolutions where approximately the same absolute amount of torque is applied to clutch 28.

FIG. 3 is an example of one embodiment of the present disclosure. According to other embodiments, the absolute amount of torque applied to clutch 28 at the beginning (ex. zero revolutions) and the end (ex. 13 revolutions) may be different. Preferably, the absolute amount of torque applied to clutch 28 initially decreases toward zero as lower and upper rollers 18, 24 rotate and then increases away from zero as the lower and upper rollers 18, 24 continue to rotate to the maximum number of revolutions (ex. 13 revolutions in the present example).

The amount of force and resulting torque provided by hem bar 20 and fabric 16 depend on several factors including the dimensions of each. For example, the width of the window in which window shade system 10 is installed with impact length of hem bar 20 and the width of fabric 16. These dimensions impact the size and therefore the weight of each which impacts the amount of force and torque attributable to hem bar 20 and fabric 16. Similarly, the height of the window will impact the length of fabric 16, which impacts the weight thereof and the amount of force and torque attributable to fabric 16. The materials selected for hem bar 20 and fabric 16 also impact their weight. For example, depending on the installation, a lighter fabric may be selected rather than a heavier fabric to control the amount of light that passes through fabric 16 and/or for aesthetic reasons. Based on these and other variables, the amount of torque provided by upper torque generator 38 can be adjusted to balance the beginning torque (ex. when fabric 16 is fully lowered) and the ending torque (ex. when fabric 16 is fully raised) applied to clutch 28.

The beginning torque and ending torque applied to clutch 28 can be adjusted by modifying the amount of preloading of upper torque generator 38. In an example where a torsion spring is provided for upper torque generator 38, the torsion spring is pre-wound to provide a predetermined about of negative torque at the beginning and ending of unwrapping fabric 16. In the present example, the torsion spring has a spring constant of 0.7071 in-lb per revolution. To balance the beginning and end torque applied to clutch 28, torsion spring is prewound 22.7 times to provide a beginning torque of negative 16.23 in-lb. As fabric 16 is raised and upper roller 24 revolves, the absolute amount of negative torque provided by torsion spring 38 decreases. As shown in FIG. 3, initially (i.e. at zero revolutions), negative torque is applied to clutch 28 as shown in curve 48. As the amount of negative torque provided by upper torque generator 38 decreases and the weight of unwrapped fabric 16 increases, the absolute torque applied to clutch 28 decreases to zero at which point the torque applied to clutch 28 turns positive and increases (from left to right in FIG. 3). At the end of travel of fabric 16 (ex. when fabric is fully raised), torque generator 38 is applying its least absolute amount of torque to clutch 28 and unwrapped fabric 16 is contributing its most torque to clutch 28. By pre-winding the torsion spring, the absolute value of torque applied to clutch 28 at the beginning of unwrapping fabric 16 equals the absolute value of torque applied to clutch 28 at the end of unwrapping fabric 16. However, the direction of the torque applied to clutch 28 at the beginning of unwrapping fabric 16 was negative and the direction of torque applied to clutch 28 at the end of unwrapping fabric 16 was positive.

According to the present disclosure, clutch 28 may be a manually operated bi-directional clutch as discussed above. Such a manual clutch requires an amount of force to be applied to either right or left sides 32, 34 of bead chain 30 before it permits upper roller 24 to rotate in the respective direction of the applied force. According to the present embodiment, the amount of required force to release the manual clutch is about 2 pounds. Thus, to manually raise or lower fabric 16, a user must pull with enough force on respective right or left sides 32, 34 to overcome the 2 pound release force in addition to the torque applied to clutch 28 discussed above. For example, to raise fabric 16 at 10 revolutions, 5.77 pounds of force must be applied to left side 34 of chain to overcome the clutch release force of 2 pounds and the 3.77 pounds of force resulting from the 3.77 in-lb of torque applied through a one inch radius of upper roller 24. To lower fabric 15 at 10 revolutions, only 2 pounds of force are required on right side 32 because the torque applied to clutch 28 encourages the lowering of fabric 16. Thus, the amount of force applied to chain 30 to move fabric 16 up or down at the same roller position is different depending upon whether fabric is being raised or lowered. As shown in FIG. 3, the amount of force required to raise fabric 16 is initially 2 pounds (to release clutch 28) until 6.5 revolutions (i.e. half the revolutions to fully raise fabric 16 according to the exemplary embodiment). After 6.5 revolutions, the amount of required force increased from 2 pounds to about 9 pounds (2 pounds to release clutch 28 and 7 pounds to overcome the torque applied to clutch 28). To lower fabric 16 from the fully raised position (13 revolutions according to the present example) requires 2 pounds of force until 6.5 revolutions. After 6.5 revolutions, the amount of required force increases from two pounds to about 9 pounds (2 pounds to release clutch 28 and 7 pounds to overcome the torque applied to clutch 28). Thus, according to the presently preferred embodiment, the amount of required force to raise fabric 16 is substantially constant (ex. 2 pounds) from the lower most position of fabric 16 until the midpoint of raising fabric 16 and then increases. Similarly, the amount of force required to lower fabric 16 from the highest most position of fabric 16 until the midpoint of lowering fabric 16 is substantially constant (ex. 2 pounds) and then increases. According to other embodiments, different amounts of force and/or torque are required to raise and/or lower fabric 16 and the crossover between negative and positive torque applied to clutch 28 may be offset from the midpoint between the fully raised and fully lowered positioned of fabric 16.

Clutch 28 will resist a pre-determined amount of maximum torque resistance before it will “slip” allowing upper roller 24 to rotate. According to the present disclosure, this maximum torque resistance is about 15-16 in-lb. Preferably, the maximum absolute torque applied to clutch 28 is less than 15-16 in-lb (positive or negative) to avoid slipping. By pre-loading upper torque generator 38, the maximum absolute amount of torque applied to clutch 28 can be optimized based on the size of hem bar 20 and fabric 16 to avoid window shade configurations that apply force to clutch 28 that exceeds its maxima torque resistence.

As mentioned above, one embodiment of clutch 28 is an electric motor 214 with a brake (see FIG. 12). The amount of torque output from electric motor 214 to rotate upper roller 24 depends on the rotational position of upper roller 24 and the direction of required rotation. According to one embodiment of the present disclosure, when clutch 28 is an electric motor 214, no upper torque generator 38 is provided. As such, the negative torque of curve 46 shown in FIG. 3 is not provided and does not impact the torque applied to clutch 28 (i.e. electric motor 214). Because no negative torque is provided, the torque applied to clutch 28 is positive throughout the travel of fabric 16. Thus, to raise fabric 16, electric motor 214 overcomes this positive torque to raise fabric 16. To lower fabric 16, the brake of electric motor 214 is released and the torque resulting from the weight of hem bar 20, fabric 16, and the torque of lower torque generator 36 are sufficient to lower fabric 16. If desirable, the electric motor 214 can also output positive torque to lower fabric 16. According to an alternative embodiment of the present disclosure, an upper torque generator 38 is provided when clutch 28 is an electric motor 214.

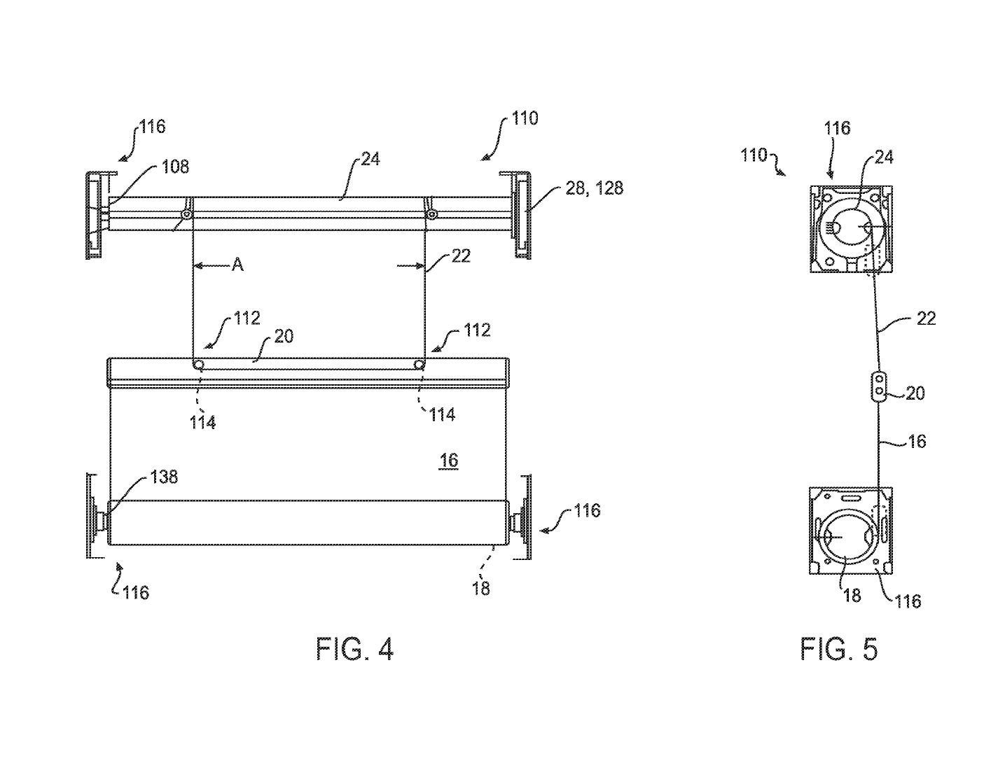

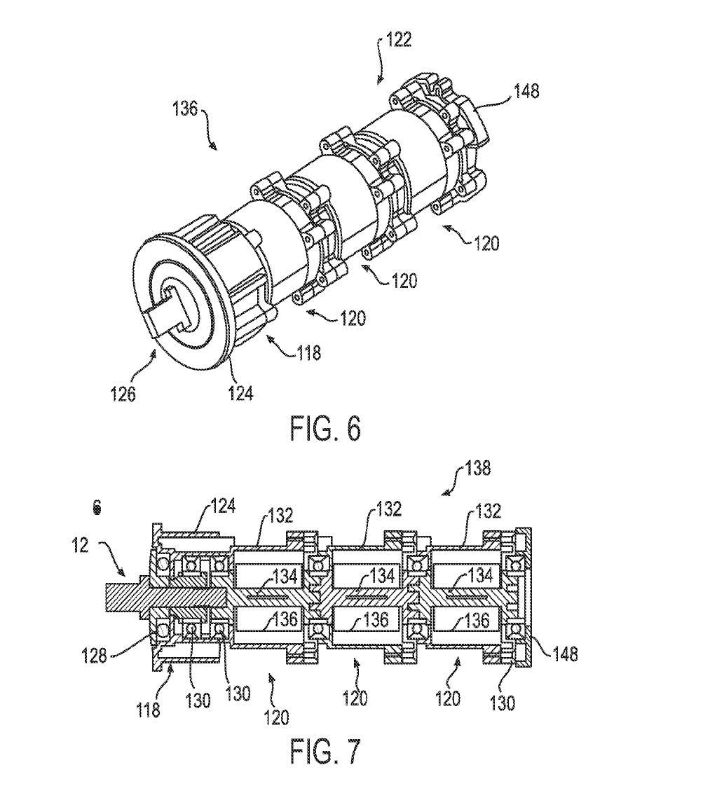

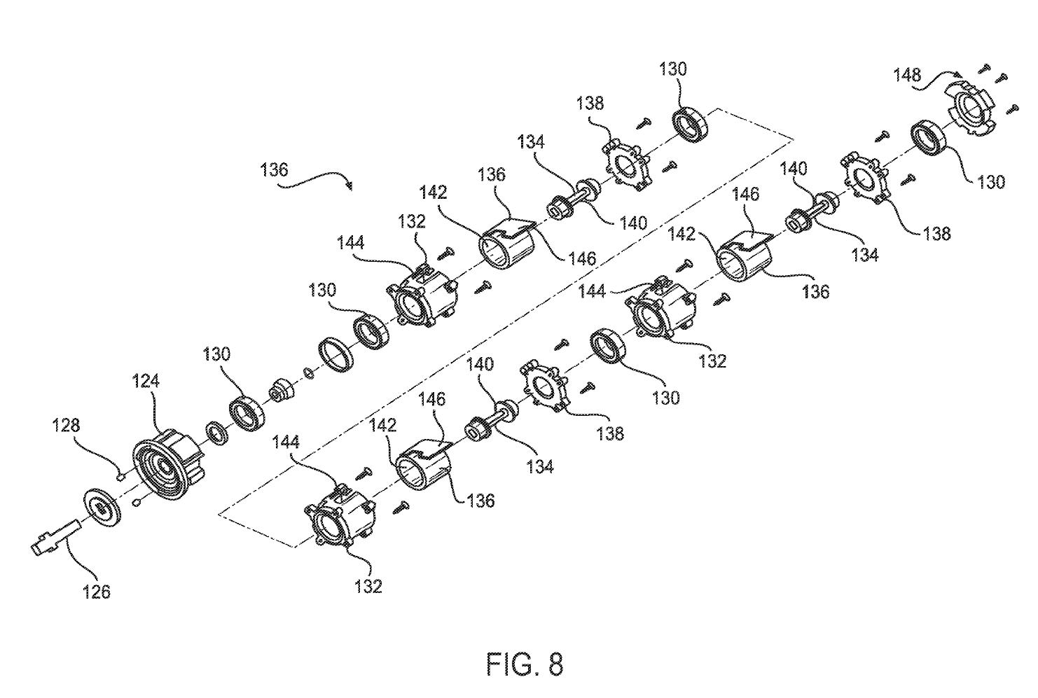

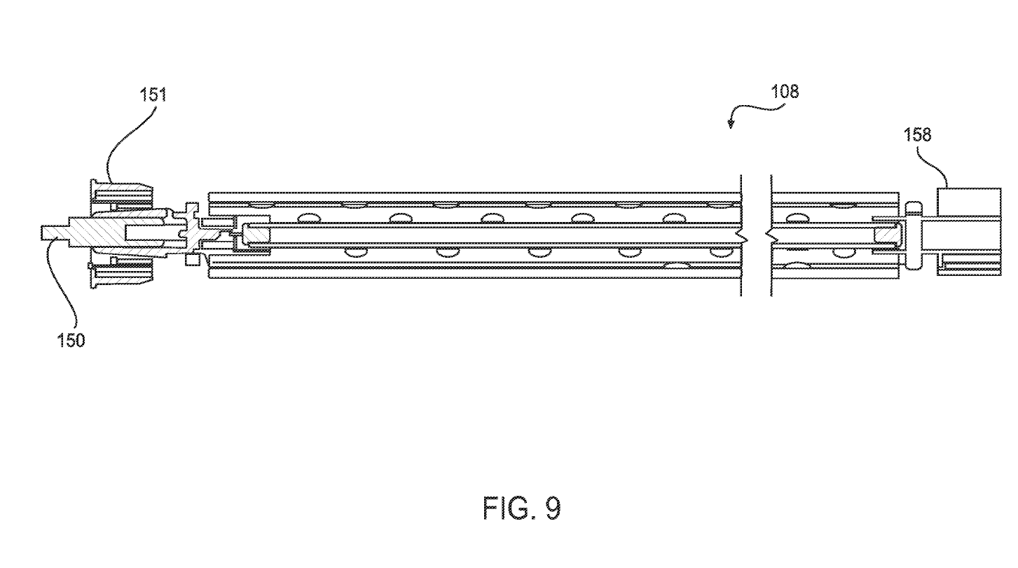

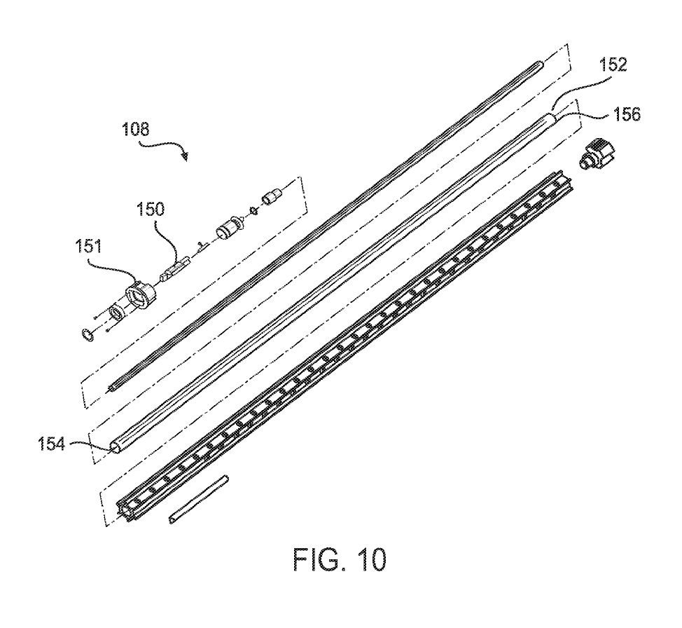

A preferred embodiment window shade system 110 is shown in FIGS. 4 and 5 including clutch 28 as a manually operated clutch 128 (chain 30 not shown). Lower torque generator 36 of window shade system 110 is a substantially constant torque spring assembly 138 shown in FIGS. 6-8 and upper torque generator 38 is a torsion spring assembly 108 shown in FIGS. 9 and 10. As shown in FIG. 4, upper roller 24 acts as a cable drum upon which cable 22 wraps and unwraps during respective raising and lowering of fabric 16. Hem bar 20 is hollow and includes a pair of hole 112 in its upper surface through which cable 22 passes. Hem bar 20 includes a pair of pulleys 114 upon which cable 22 rides to balance the force applied to hem bar 20 by the respective side of cable 22. The terminal ends of cable 22 are attached to upper roller 24. As shown in FIG. 4, cables 22 are inset from the ends of hem bar 20. According to the present embodiment, a distance A between the lengths of cable 22 is about 56% of the length of hem bar 20 plus a factor of 0.4 inches. Bracket and pivot assemblies 116 support lower and upper rollers 18, 24.

As shown in FIGS. 6-8, spring assembly 138 includes a plurality of modules 118, 120 that cooperate to define an outer housing 122 that houses various internal components of spring assembly 138. Housing 122 rotates with lower roller 18 during use. Input module 118 includes a housing 124, an input shaft 126, a pair of individual ball bears 128, and a pair of shielded ball bearings 130. When installed in lower roller 18 and supported on one of bracket assemblies 116, input shaft 126 is blocked against rotation as housing 124 rotates with lower roller 18. Ball bearings 128, 130 facilitate the relative rotation between housing 124 and input shaft 126.

Spring modules 120 are substantially identical. Each spring module 120 includes a housing 132 secured to housing 124 against rotation thereto, an input shaft 134 coupled to input shaft 126 against rotation thereto, a spring 136, a shielded ball bearing 130, and a cap 138 secured to housing 132. Spring 136 consists of coiled strip of sheet metal about 0.005″ thick and 1.00″ wide. Input shaft 134 includes a slot 140 to receive an inner end 142 of spring 136 and housing 132 includes an outer slot 144 to receive a slotted outer end 146 of clock 136.

When installed in lower roller 18 and supported by bracket assembly 116, inner end 142 of spring 136 remains stationary as lower roller 18 rotates and outer end 146 of spring 136 rotates. The relative rotational movement between inner and outer ends 142, 144 creates substantially constant torque therebetween. Because inner end 142 is “grounded” by input shafts 126, 134 and bracket assembly 116, the substantially constant torque is applied to lower roller 18 through housing 132 of composite housing 122. This constant torque is applied to fabric 16, which is converted to force applied to hem bar 20 and cable 22 as discussed above. This torque assists in retracting or wrapping fabric 16 on lower roller 18 during lowering of fabric 16. Spring assembly 138 further includes an adaptor 148 sized to mate with the interior of lower roller 18 to transmit torque therebetween.

As shown in FIGS. 6-8, spring assembly 138 includes one input module 118 and three spring modules 120. To varying the amount of constant torque, fewer or more spring modules 120 may be included in spring assembly 138. To facility the use of spring module 138 in different size rollers 18, different diameter housings 124 may be provided that having smaller or larger diameters than illustrated housing 124. Similarly, different diameter adaptors 148 may be provided having smaller or larger diameters than illustrated adaptor 148. Unlike housing 124 and adaptor 148, the diameter of housings 132 of spring modules 120 need not change as the diameter of lower roller 18 changes.

Upper torque generator 38 is illustrated in FIGS. 9 and 10 as a torsion spring assembly 108. Torsion spring assembly 108 includes an input shaft 150 grounded to one of bracket assemblies 116, a first adaptor 151 coupled to upper roller 24, a torsion spring 152 having a first end 154 coupled to input shaft 150 against rotation and a second end 156 coupled to a second adaptor 158 that rotates with upper roller 24 along with first adaptor 151. During installation, an installer rotates upper roller 24 a pre-determined number of times to pre-load torsion spring 152 as discussed above. Upon completion of the pre-loading, cable 22 is coupled to upper roller 24 so that torsion spring 152 applies tension to cable 22 and assists in raising fabric 16 against gravity and the constant torque applied by lower torque generator 36.

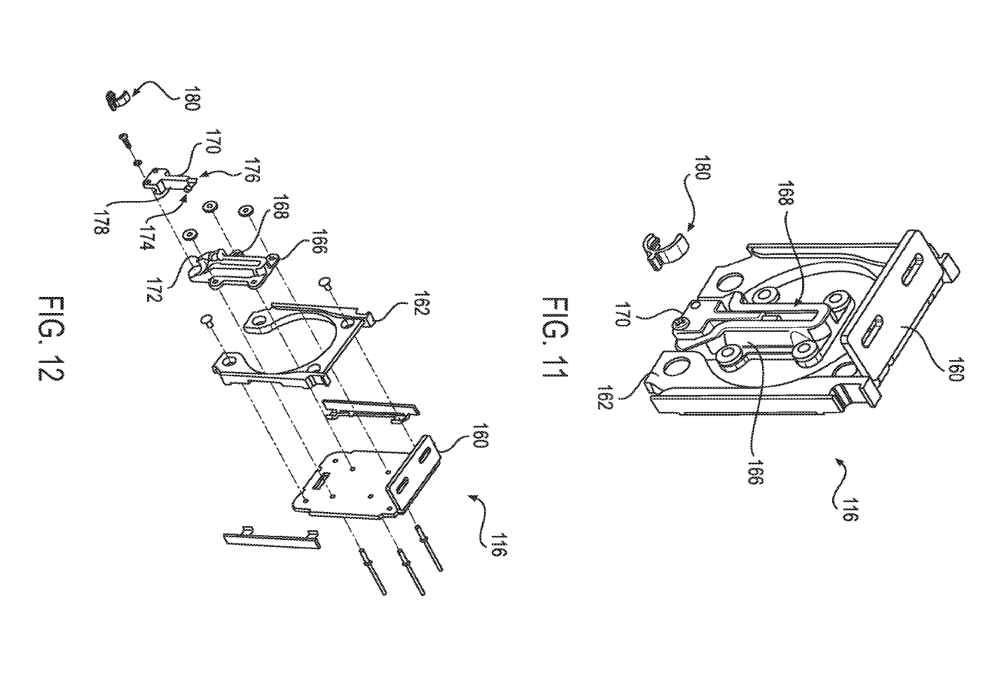

According to one embodiment of the present disclosure, at least one of the bracket assemblies 116 includes an adjustable idler as shown in FIGS. 11 and 12. Bracket assembly 116 includes a bracket 160, a base 162 coupled to bracket 160, a receiver 166 having a slot 168 sized to receive an input shaft, such as input shaft 150 mentioned above, and slide assembly 170 coupled to receiver 166. During installation, bracket 160, base 162, and receiver 166 are mounted to a surface, such as a window opening wall (not shown). Upper roller 24 with torsion spring assembly 108 positioned therein are then installed. During this installation, input shaft 150 of torsion spring assembly 108 is slid up through an open end 172 of slot 168. Next, slide assembly 170 is inserted into open end 172 trapping input shaft 150 in slot 168. Slide assembly 170 is then coupled to receiver 166. Slide assembly 170 includes a pair of protrusions 174 that have a combined width wider than the width of slot 168 that prevents slides assembly 170 from coming out of slot 168. Slide assembly 170 further includes a set screw 176 that extends from a top of a base 178 of slide assembly 170 to support input shaft 150 thereon. Set screw 176 has a head (not shown) accessible through a bottom of base 178. If upper roller 24 is not level, an installer can turn set screw 176 to raise or lower set screw 176 within base 178 to raise or lower the end of upper roller 24 supported by bracket assembly 116.

Input shaft 150 of torsion spring assembly 108 is spring loaded so it can be pushed into first adaptor 151 to facilitate insertion of input shaft 150 into slot 168. Bracket assembly 116 includes a retaining clip 180 that blocks retraction of input shaft 150.

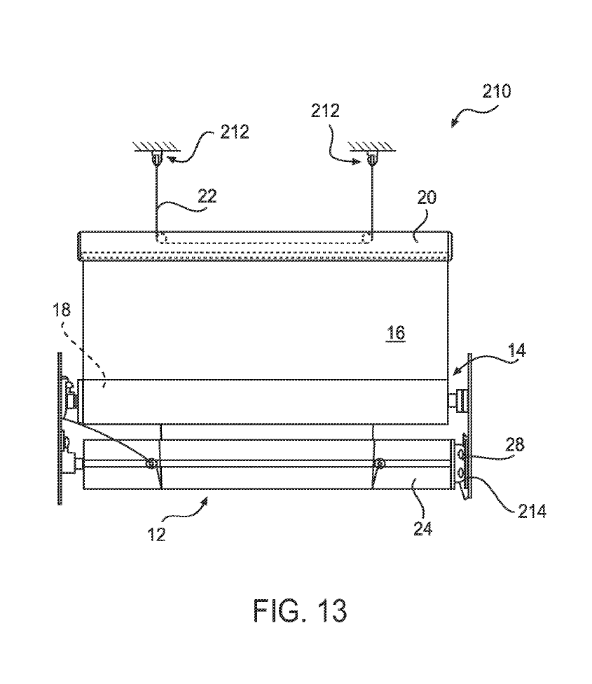

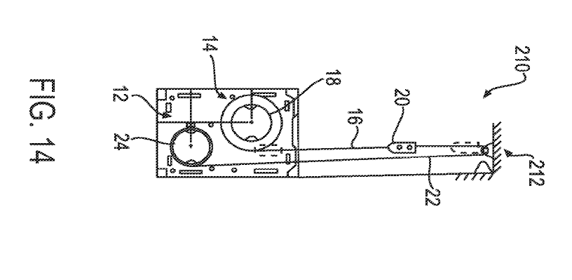

An alternative embodiment window shade system 210 is shown in FIGS. 13 and 14. Window shade system 210 includes “lower” roller assembly 14 and “upper” roller assembly 12 discussed above. However, upper roller assembly 12 is positioned at a position below lower roller assembly 14. Additionally, roller assemblies 12, 14 are supported on the same bracket assemblies rather than separate bracket assemblies 116. Cable 22 is supported near the top of window by a pair of pulleys 212.

Although the present invention has been described in detail with reference to preferred embodiments, variations and modifications exist within the scope and spirit of the present invention as described and defined in the following claims.

1. A window shade system including
a roller,
fabric coupled to the roller to wrap and unwrap from the roller,
a roller adapter sized to be received within a window shade roller,
a drum,
a flexible line supporting the fabric and coupled to the drum to wrap and unwrap from the drum,
a clutch coupled to the drum to control rotation of the drum,
a first torque generator urging the fabric in a first direction, and
a second torque generator urging the fabric in a second direction opposite the first direction.

2. The window shade system of claim 1, wherein the first torque generator applies substantially constant torque during rotation of at least a portion of the first torque generator.

3. The window shade system of claim 1, wherein the second torque generator applies torque during rotation of at least a portion of the first torque generator, the absolute magnitude of the applied torque increases with the rotation.

4. The window shade system of claim 3, wherein the first torque generator applies substantially constant torque during rotation of at least a portion of the first torque generator.

5. A window shade system including
a roller,
fabric coupled to the roller to wrap and unwrap from the roller,
a roller adapter sized to be received within a window shade roller,
a drum,
at least one flexible line supporting the fabric and coupled to the drum to wrap and unwrap from the drum, and
a clutch coupled to the drum to control rotation of the drum, the fabric being moveable between a first position and a second position, torque applied to the clutch being in a first direction when the fabric is in the first position and being in a second direction opposite the first direction when the fabric is in the second position.

6. The window shade system of claim 5, wherein the fabric includes an intermediate position between the first and second positions, and the torque applied to the clutch being zero when the fabric is in the intermediate position.

7. The window shade system of claim 5, further comprising a torque generator that applies torque to the clutch in the second direction, wherein the at least one flexible line applies torque to the clutch in first direction.

8. The window shade system of claim 7, wherein the torque generator applies less torque to the clutch than the at least one flexible line when the fabric is in the first position and the torque generator applies more torque to the clutch than the at least one flexible line when the fabric is in the second position.

9. A window shade system including
a roller,
fabric coupled to the roller to wrap and unwrap from the roller,
a roller adapter sized to be received within a window shade roller,
a drum,
a flexible line supporting the fabric and coupled to the drum to wrap and unwrap from the drum, and
a clutch coupled to the drum to control rotation of the drum, the fabric being moveable between a first position, a second position, and an intermediate position between the first and second positions, the absolute torque applied to the clutch decreases when the fabric moves between the first and intermediate positions and increases when the fabric moves between the intermediate and second positions.

10. The window shade system of claim 9, wherein the torque applied to the clutch in the first position is positive and the torque applied to the clutch in the second position is negative.

11. The window shade system of claim 9, further comprising a first torque generator that applies substantially constant torque to the flexible line.

12. The window shade system of claim 11, further comprising a second torque generator that applies variable torque to the clutch 9, wherein the absolute torque applied to the clutch is zero when the fabric is in the intermediate position.

13. A window shade system including
a roller,
fabric coupled to the roller to wrap and unwrap from the roller,
a roller adapter sized to be received within a window shade roller, and
a clutch coupled to the drum to control rotation of the drum, the clutch including a pull line operable to release the clutch and wrap or unwrap the fabric from the roller from first, second, and intermediate positions, a first required amount of force applied to the pull line during movement of the fabric between the first and intermediate positions being substantially constant, a second required amount of force applied to the pull line during movement of the fabric between the intermediate and second positions, the second required amount increasing from the first amount of required force during movement of the fabric from the intermediate position to the second position.

14. The window shade system of claim 13, further comprising a first torque generator that applies substantially constant torque to the fabric.

15. The window shade system of claim 11, further comprising a second torque generator that applies variable torque to the clutch

16. A window shade system including
a roller,
fabric coupled to the roller to wrap and unwrap from the roller,
a roller adapter sized to be received within a window shade roller,
a drum,
at least one flexible line supporting the fabric and coupled to the drum to wrap and unwrap from the drum,
a clutch coupled to the drum to control rotation of the drum, the clutch having a maximum torque limit, and
a torque generator coupled to the clutch, the at least one flexible line applying torque above the maximum torque limit.

17. A window shade system including
a roller,
fabric coupled to the roller to wrap and unwrap from the roller,
a roller adapter sized to be received within a window shade roller,
a drum,
at least one flexible line supporting the fabric and coupled to the drum to wrap and unwrap from the drum, and
a torque generator coupled to at least one flexible line, the torque generator including a plurality of spring modules applying substantially constant torque to the at least one flexible line during rotation of at least a portion of the torque generator.
